(19) United States
(12) Patent Application Publication
(10) Pub. No.: US 2022/0173432 A1
(43) Pub. Date: Jun. 2, 2022

(54) ALL SOLID STATE BATTERY

(71) Applicant: TOYOTA JIDOSHA KABUSHIKI KAISHA, Toyota-shi Aichi-ken (JP)

(72) Inventor: Takamasa Ohtomo, Miyoshi-shi Aichi-ken (JP)

(73) Assignee: TOYOTA JIDOSHA KABUSHIKI KAISHA, Toyota-shi Aichi-ken (JP)

(21) Appl. No.: 17/532,171

(22) Filed: Nov. 22, 2021

(30) Foreign Application Priority Data
Dec. 2, 2020 (JP) 2020-200373

(51) Int. Cl. H01M 10/0562; H01M 10/0585; H01M 4/04; H01M 4/66; H01M 10/0525

(52) U.S. Cl. CPC H01M 10/0562; H01M 10/0585; H01M 4/0404; H01M 4/621; H01M 10/0525; H01M 2300/0068; H01M 4/661

(57) ABSTRACT

A main object of the present disclosure is to provide an all solid state battery of which calorific value is little even when internal short circuit occurs due to factors such as pricking of a conductive member. The present disclosure achieves the object by providing an all solid state battery comprising a cathode active material layer and a high rigidity cathode current collector, wherein the high rigidity cathode current collector contains a metal element, and Young's modulus of the high rigidity cathode current collector is 96.5 GPa or more.

### CROSS-REFERENCE TO RELATED APPLICATION This application claims priority to Japanese Patent Application No. 2020-200373 filed on Dec. 2, 2020, incorporated herein by reference in its entirety.

### TECHNICAL FIELD

The present disclosure relates to an all solid state battery.

### BACKGROUND ART

An all solid state battery is a battery including a solid electrolyte layer between a cathode active material layer and an anode active material layer, and one of the advantages thereof is that the simplification of a safety device may be more easily achieved compared to a liquid-based battery including a liquid electrolyte containing a flammable organic solvent.

It has been known that a metal is used as a cathode current collector for collecting currents of the cathode active material layer and an anode current collector for collecting currents of the anode active material layer. For example, Patent Literature 1 discloses an all solid state battery using a metal, of which elongation rate is 22% or more, as a cathode side metal layer (cathode current collector).

Also, although it is not a technology relating to an all solid state batter, Patent Literature 2 discloses a non-aqueous liquid electrolyte secondary battery including a metal foil, of which Young's modulus is 20 multiplied by 10¹⁰ N/m² or less. Also, Patent Literature 3 discloses a cathode for non-aqueous liquid electrolyte secondary battery including a cathode current collector of which Young's modulus is 6.5 N/mm² or less.

### CITATION LIST

### Patent Literatures

Patent Literature 1: Japanese Patent Application Laid-Open (JP-A) No. 2015-065029

Patent Literature 2: JP-A No. H11-126613

Patent Literature 3: International Application Publication: WO 2014/155990

### SUMMARY OF DISCLOSURE

### Technical Problem

For example, when internal short circuit occurs in an all solid state battery due to factors such as a pricking of a conductive member, heat is generated in the all solid state battery due to currency flow that occurs along with the internal short circuit. The calorific value is little. The present disclosure has been made in view of the above circumstances, and a main object of thereof is to provide an all solid state battery of which calorific value is little even when internal short circuit occurs due to factors such as pricking of a conductive member.

### Solution to Problem

The present disclosure provides an all solid state battery comprising a cathode active material layer and a high rigidity cathode current collector, wherein the high rigidity cathode current collector contains a metal element, and Young's modulus of the high rigidity cathode current collector is 96.5 GPa or more.

According to the present disclosure, usage of the high rigidity cathode current collector having the specified Young's modulus allows an all solid state battery of which calorific value is little even when internal short circuit occurs due to factors such as pricking of a conductive member.

In the disclosure, the cathode active material layer and the high rigidity cathode current collector may be in a non-contact state.

In the disclosure, the high rigidity cathode current collector may contain, as the metal element, a first metal element of which Young's modulus in a simple substance of metal is 96.5 GPa or more.

In the disclosure, the high rigidity cathode current collector may contain at least one kind of Zn, Fe, Ni, Pt, Ir, Re, W, Ta, Pd, Rh, Ru, Mo, Nb, Cu, Co, Mn, Cr, V, Ti and Be as the first metal element.

In the disclosure, the high rigidity cathode current collector may contain Zn as the first metal element.

In the disclosure, the high rigidity cathode current collector may contain Fe as the first metal element.

In the disclosure, the high rigidity cathode current collector may contain Ni as the first metal element.

In the disclosure, the high rigidity cathode current collector may be a simple substance of metal containing the metal element.

In the disclosure, the high rigidity cathode current collector may be an alloy containing the metal element.

In the disclosure, the alloy may contain a first metal element of which Young's modulus in a simple substance of metal is 96.5 GPa or more, and a second metal element of which Young's modulus in a simple substance of metal is less than 96.5 GPa.

In the disclosure, the high rigidity cathode current collector may include a coating layer containing a carbon material on a surface of the cathode active material layer side.

In the disclosure, the coating layer may contain an inorganic filler.

In the disclosure, the all solid state battery comprises a unit cell; and the unit cell includes: an anode current collector, a first structure body arranged on one surface of the anode current collector, and a second structure body arranged on the other surface of the anode current collector; the first structure body includes a first anode active material layer, a first solid electrolyte layer, a first cathode active material layer and a first cathode current collector in an order along with a thickness direction from the anode current collector side; the second structure body includes a second anode active material layer, a second solid electrolyte layer, a second cathode active material layer and a second cathode current collector in an order along with a thickness direction from the anode current collector side; and at least one of the first cathode current collector and the second cathode current collector may be the high rigidity cathode current collector.

In the disclosure, the all solid state battery comprises a plurality of unit cells; the plurality of unit cells are layered along with a thickness direction; and in the layered plurality of unit cells, when a cathode current collector positioned in the outermost side is regarded as an outermost cathode current collector, only the outermost cathode current collector may be the high rigidity cathode current collector.

### Effects of Disclosure

The all solid state battery in the present disclosure exhibits an effect such that the calorific value is little even when internal short circuit occurs due to factors such as pricking of a conductive member.

### BRIEF DESCRIPTION OF DRAWINGS

FIG. 1 is a schematic cross-sectional view exemplifying the all solid state battery in the present disclosure.

FIG. 2 is a schematic cross-sectional view exemplifying the cathode in the present disclosure.

FIG. 3 is a schematic cross-sectional view exemplifying the all solid state battery in the present disclosure.

FIG. 4 is a schematic cross-sectional view exemplifying the unit cell in the present disclosure.

FIG. 5 is a schematic cross-sectional view exemplifying the all solid state battery in the present disclosure.

FIG. 6 is a schematic cross-sectional view exemplifying the all solid state battery in the present disclosure.

### DESCRIPTION OF EMBODIMENTS

The all solid state battery in the present disclosure is hereinafter explained in details with reference to drawings. Each drawing described as below is a schematic view, and the size and the shape of each portion are appropriately exaggerated in order to be understood easily. Further, in each drawing, hatchings or reference signs are appropriately omitted. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

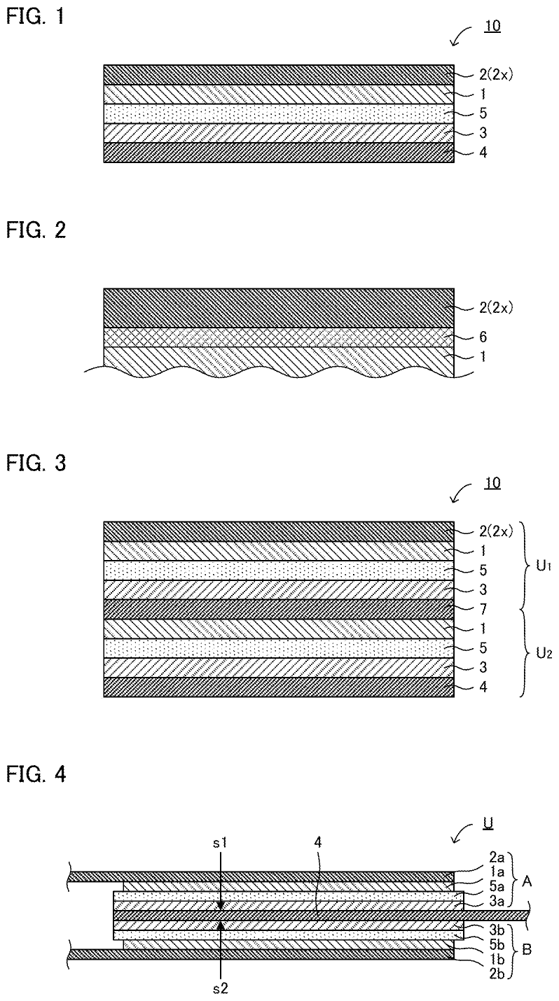

FIG. 1 is a schematic cross-sectional view exemplifying the all solid state battery in the present disclosure. All solid state battery 10 illustrated in FIG. 1 includes cathode active material layer 1, cathode current collector 2 for collecting currents of the cathode active material layer 1, anode active material layer 3, anode current collector 4 for collecting currents of the anode active material layer 3, and solid electrolyte layer 5 arranged between the cathode active material layer 1 and the anode active material layer 3. The cathode current collector 2 is high rigidity cathode current collector 2x with a specified Young's modulus.

According to the present disclosure, usage of the high rigidity cathode current collector with the specified Young's modulus allows an all solid state battery of which calorific value is little even when internal short circuit occurs due to factors such as pricking of a conductive member. As described above, when internal short circuit occurs in an all solid state battery due to factors such as pricking of a conductive member, heat is generated in the all solid state battery due to currency flow that occurs along with the internal short circuit. In particular, when the cathode current collector is pulled inside the all solid state battery by the conductive member and the cathode current collector having small resistance contacts with the anode current collector, current amount increases and a presumed case is that the calorific value is increased thereby. In contrast, in the present disclosure, the high rigidity cathode current collector with the specified Young's modulus is used, and thus the deformation of the high rigidity cathode current collector does not easily occur with respect to stress generated during the pricking of the conductive member. Thus, the high rigidity cathode current collector being pulled inside the all solid state battery by the conductive member can be prevented to reduce calorific value.

1. Cathode

The cathode in the present disclosure includes a cathode active material layer containing a cathode active material, and a cathode current collector for collecting currents of the cathode active material layer.

(1) Cathode Current Collector

The all solid state battery in the present disclosure comprises, as a cathode current collector, a high rigidity cathode current collector, wherein the high rigidity cathode current collector contains a metal element, and Young's modulus of the high rigidity cathode current collector is 96.5 GPa or more.

There are no particular limitations on the metal element included in the high rigidity cathode current collector. The high rigidity cathode current collector may contain just one kind of the metal element, and may contain two kinds or more thereof. In some embodiments, the high rigidity cathode current collector contains, as the metal element, a first metal element of which Young's modulus in a simple substance of metal is 96.5 GPa or more. The high rigidity cathode current collector may contain just one kind of the aforementioned metal element, and may contain two kinds or more thereof. Examples of the first metal element may include Zn, Fe, Ni, Pt, Ir, Re, W, Ta, Pd, Rh, Ru, Mo, Nb, Cu, Co, Mn, Cr, V, Ti and Be.

The high rigidity cathode current collector may or may not contain, as the metal element, a second metal element of which Young's modulus in a simple substance of metal is less than 96.5 GPa. Examples of the second metal element may include Bi, Pb, Au, Sn, In, Cd, Ag, Ca, Al, and Mg.

The high rigidity cathode current collector may be a simple substance of metal, and may be an alloy. In the latter case, the high rigidity cathode current collector contains at least the first metal element, and contains the first metal element as a main component. “As a main component” means that the weight proportion of the metal element is the most among all the metal elements included in the alloy. Also, the high rigidity cathode current collector contains Zn as the metal element, and contains Zn as a main component. Further, the high rigidity cathode current collector contains Fe as the metal element, and contains Fe as a main component. Furthermore, the high rigidity cathode current collector contains Ni as the metal element, and contains Ni as a main component.

The Young's modulus of the high rigidity cathode current collector is usually 96.5 GPa or more, may be 120 GPa or more, may be 150 GPa or more, and may be 200 GPa or more. When the Young's modulus of the high rigidity cathode current collector is too small, there is a possibility that the cathode current collector being pulled inside the all solid state battery by the conductive member may not be sufficiently prevented. Incidentally, the Young's modulus of the high rigidity cathode current collector may be 205 GPa or more. Meanwhile, the Young's modulus of the high rigidity cathode current collector is, for example, 500 GPa or less. The Young's modulus can be obtained by a tensile test method in accordance with JIS Z2201 “Metal Material Tensile Test Piece” 22241 “Metal Material Tensile Test Method”.

Examples of the shape of the high rigidity cathode current collectors may include a foil shape and a mesh shape. The thickness of the high rigidity cathode current collector is, for example, 0.1 μm or more and may be 1 μm or more. If the high rigidity cathode current collector is too thin, there is a possibility that the current collecting properties are degraded. Meanwhile, the thickness of the high rigidity cathode current collector is, for example, 1 mm or less and may be 100 μm or less. If the high rigidity cathode current collector is too thick, there is a possibility that the volume energy density of the all solid state battery may be decreased.

The cathode active material layer and the high rigidity cathode current collector may be in a non-contact state. When the both are in the non-contact sate, the cathode current collector is more easily pulled inside the all solid state battery by the conductive member, compared with when the both are in a contact state. Even in such a state, usage of the high rigidity cathode current collector can prevent from being pulled inside the all solid state battery. “In a non-contact state” refers to, when the high rigidity cathode current collector is fixed on a pedestal, a part of cellophane tape (No405, industrial, from NICHIBAN Co., Ltd.) is put on the cathode active material layer, and then the cellophane tape is pulled to the thickness direction (vertical direction), the state where each of the high rigidity cathode current collector and the cathode active material layer are peeled off without remainings. Incidentally, the evaluation may be conducted in reverse order such that the cathode active material layer is fixed and a part of the cellophane tape is put on the high rigidity cathode current collector. For example, when slurry containing a cathode active material and a binder is pasted on the high rigidity cathode current collector to form a cathode active material layer, the cathode active material layer and the high rigidity cathode current collector are strongly adhered to each other by the binder included in the slurry. For this reason, the non-contact state would not be usually obtained in this case. On the other hand, as described later in Examples, when a cathode active material layer is formed by using a transfer foil (Al foil), being pressed and then peeling off the transfer foil, and the high rigidity cathode current collector is arranged on the exposed cathode active material layer, the non-contact state may be obtained.

Also, as shown in FIG. 2, the high rigidity cathode current collector 2x may include coating layer 6 containing a carbon material on a surface of the cathode active material layer 1 side. When the coating layer 6 is arranged between the high rigidity cathode current collector 2x and the cathode active material layer 1, the contact resistance of the both may be reduced.

The coating layer is a layer containing at least a carbon material. Examples of the carbon material may include carbon black such as furnace black, acetylene black, Ketjen black, and thermal black; carbon fiber such as carbon nanotube and carbon nanofiber; activated carbon, carbon, graphite, graphene, and fullerene. Examples of the shape of the carbon material may include a granular shape. The proportion of the carbon material included in the coating layer is, for example, 5 volume % or more and 95 volume % or less.

The coating layer may further contain a resin. For example, by adding a lot of resin, coating layer with flexibility may be obtained. With high flexibility, contact area of the coating layer and the cathode active material layer on the cathode current collector is enlarged by a restraining pressure applied to the battery, and the contact resistance may be reduced. Also, when a resin is added a lot, a coating layer having PTC properties may be obtained. Here, PTC refers to Positive Temperature Coefficient, and the PTC properties mean properties where resistance changes with a positive coefficient along with temperature rise. In other words, the volume of the resin included in the coating layer expands along with temperature rise, and the resistance of the coating layer increases. As a result, the calorific value can be reduced even when factors such as internal short circuit occurs.

Examples of the resin may include a thermoplastic resin. Examples of the thermoplastic resin may include polyvinylidene fluoride (PVDF), polypropylene, polyethylene, polyvinyl chloride, polystyrene, an acrylonitrile butadiene styrene (ABS) resin, a methacrylic resin, polyamide, polyester, polycarbonate, and polyacetal. The melting point of the resin is, for example, 80° C. or more and 300° C. or less. The proportion of the resin included in the coating layer is, for example, 5 volume % or more, and may be 50 volume % or more. Meanwhile, the proportion of the resin included in the coating layer is, for example, 95 volume % or less.

The coating layer may or may not contain an inorganic filler. A coating layer with high PTC properties may be obtained in the former case, and a coating layer with high electron conductivity may be obtained in the latter case. In an all solid state battery, usually, restraining pressure is applied along with a thickness direction, and thus the resin included in the coating layer may be deformed or flow due to the restraining pressure, and there is a possibility that the PTC properties may not be sufficiently exhibited. In contrast, when a hard inorganic filler is added to the coating layer, the PTC properties can be sufficiently exhibited even when affected by the restraining pressure.

Examples of the inorganic filler may include a metal oxide and a metal nitride. Examples of the metal oxide may include alumina, zirconia and silica, and examples of the metal nitride may include silicon nitride. The average particle size (D₅₀) of the inorganic filler is, for example, 50 nm or more and 5 μm or less, and may be 100 nm or more and 2 μm or less. Also, the content of the inorganic filler in the coating layer is, for example, 5 volume % or more and 90 volume % or less.

The thickness of the coating layer is, for example, 1 μm or more and 20 μm or less, may be 1 μm or more and 10 μm or less.

(2) Cathode Active Material Layer

The cathode active material layer contains at least a cathode active material, and may contain at least one of a solid electrolyte, a conductive material and a binder, as required.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li(Ni_{0.5}Mn_{1.5})O₄ and Li₄Ti₅O₁₂; and an olivine type active material such as LiFePO₄, LiMnPO₄, LiNiPO₄, and LiCoPO₄. Also, as the cathode active material, sulfur (S) or lithium sulfide (Li₂S) may be used.

Also, a protective layer containing Li-ion conductive oxide may be formed on the surface of the cathode active material. The reason therefor is to inhibit the reaction of the cathode active material and the solid electrolyte. Examples of the Li-ion conductive oxide may include LiNbO₃. The thickness of the protective layer is, for example, 0.1 nm or more and 100 nm or less, and may be 1 nm or more and 20 nm or less.

Examples of the shape of the cathode active material may include a granular shape. The average particle size (D₅₀) of the cathode active material is, for example, 10 nm or more and 50 μm or less, and may be 100 nm or more and 20 μm or less. The proportion of the cathode active material in the cathode active material layer is, for example, 50 weight % or more, and may be 60 weight % or more and 99 weight % or less.

Examples of the solid electrolyte may include an inorganic solid electrolyte such as a sulfide solid electrolyte and an oxide solid electrolyte. In some embodiments, the sulfide solid electrolyte contains Li, A (A is at least one kind of P, Si, Ge, Al and B), and S. Also, the sulfide solid electrolyte includes an anion structure of an ortho composition (PS₄³⁻ structure, SiS₄⁴⁻ structure, GeS₄⁴⁻ structure, AlS₃³⁻ structure, and BS₃³⁻ structure) as the main component of an anion. The proportion of the anion structure of the ortho composition with respect to all the anion structures in the sulfide solid electrolyte is, for example, 50 mol % or more and may be 70 mol % or more. Also, the sulfide solid electrolyte may contain a lithium halide. Examples of the lithium halide may include LiCl, LiBr, and LiI.

Also, the solid electrolyte may be glass, may be crystallized glass (glass ceramic), and may be a crystal material. Examples of the shape of the solid electrolyte may include a granular shape.

Examples of the conductive material may include a carbon material such as acetylene black (AB) and Ketjen black (KB), carbon fiber, carbon nanotube (CNT), and carbon nanofiber (CNF). Further, examples of the binder may include a rubber-based binder such as butylene rubber (BR) and styrene butadiene rubber (SBR), and a fluoride-based binder such as polyvinylidene fluoride (PVDF). Also, the thickness of the cathode active material layer is, for example, 0.1 μm or more and 300 μm or less, and may be 0.1 μm or more and 100 μm or less.

2. Anode

The anode in the present disclosure includes an anode active material layer containing an anode active material, and an anode current collector for collecting currents of the anode active material layer. The anode active material layer contains at least an anode active material, and may contain at least one of a solid electrolyte, a conductive material and a binder, as required.

Examples of the anode active material may include a metal active material, a carbon active material, and an oxide active material. Examples of the metal active material may include a simple substance of metal and a metal alloy. Examples of the metal element included in the metal active material may include Si, Sn, Li, In and Al. The metal alloy is an alloy containing the aforementioned metal element as a main component. The metal alloy may be a two-component alloy, and may be a multi component alloy of three components or more. Examples of the carbon active material may include methocarbon microbeads (MCMB), highly oriented pyrolytic graphite (HOPG), hard carbon, and soft carbon. Also, examples of the oxide active material may include a lithium titanate such as Li₄Ti₅O₁₂.

The solid electrolyte, the conductive material and the binder to be used in the anode active material layer are in the same contents as those described in “1. Cathode” above; thus, the descriptions herein are omitted. Also, the thickness of the anode active material layer is, for example, 0.1 μm or more and 300 μm or less, and may be 0.1 μm or more and 100 μm or less.

Examples of the metal element included in the anode current collector may include Cu, Fe, Ti, Ni, Zn and Co. The anode current collector may be a simple substance of the aforementioned metal element, and may be an alloy containing the aforementioned metal element as a main component. Examples of the shape of the anode current collector may include a foil shape and a mesh shape. The thickness of the anode current collector is, for example, 0.1 μm or more and 1 mm or less, and may be 1 μm or more and 100 μm or less.

3. Solid Electrolyte Layer

The solid electrolyte layer is a layer arranged between the cathode active material layer and the anode active material layer. Also, the solid electrolyte layer contains at least a solid electrolyte, and may further contain a binder as required. The solid electrolyte and the binder to be used in the solid electrolyte layer are in the same contents as those described in “1. Cathode” above; thus, the descriptions herein are omitted.

The content of the solid electrolyte in the solid electrolyte layer is, for example, 10 weight % or more and 100 weight % or less, and may be 50 weight % or more and 100 weight % or less. Also, the thickness of the solid electrolyte layer is, for example, 0.1 μm or more and 300 μm or less, and may be 0.1 μm or more and 100 μm or less.

4. All Solid State Battery

The all solid state battery in the present disclosure comprises a unit cell. The “unit cell” refers to a unit configuring the battery element in the all solid state battery, which includes a cathode current collector, a cathode active material layer, a solid electrolyte layer, an anode active material layer, and an anode current collector. Incidentally, the cathode current collector in one unit cell may be used in common as the cathode current collector or the anode current collector in the other unit cell. Similarly, the anode current collector in one unit cell may be used in common as the anode current collector or the cathode current collector in the other unit cell.

The all solid state batter in the present disclosure may include just one of the unit cell, and may include two or more thereof. In the latter case, a plurality of the unit cells are usually stacked along with the thickness direction. Also, the plurality of the unit cells may be connected in series and may be connected in parallel. For example, all solid state battery 10 shown in FIG. 1 includes just one of the unit cell including cathode current collector 2, cathode active material layer 1, solid electrolyte layer 5, anode active material layer 3 and anode current collector 4. On the other hand, all solid state battery 10 shown in FIG. 3 includes unit cells U₁ and U₂ and these are connected in series. Incidentally, intermediate current collector 7 shown in FIG. 3 works both as the anode current collector in the unit cell U₁ and as the cathode current collector in the unit cell U₂. The intermediate current collector 7 may be the above described high rigidity cathode current collector (high rigidity current collector).

FIG. 4 is a schematic cross-sectional view exemplifying the unit cell in the present disclosure. Unit cell U shown in FIG. 4 includes anode current collector 4, first structure body A arranged on one surface s1 of the anode current collector 4, and second structure body B arranged on the other surface s2 of the anode current collector 4. Also, the first structure body A includes, in the order along with the thickness direction from the anode current collector 4 side, first anode active material layer 3a, first solid electrolyte layer 5a, first cathode active material layer la, and first cathode current collector 2a. Meanwhile, the second structure body B includes, in the order along with the thickness direction from the anode current collector 4 side, second anode active material layer 3b, second solid electrolyte layer 5b, second cathode active material layer 1b, and second cathode current collector 2b. At least one of the first cathode current collector 2a and the second cathode current collector 2b is the above described high rigidity cathode current collector.

In unit cell U shown in FIG. 4, constitutions of the layers other than anode current collector 4 are symmetry on the basis of the anode current collector 4, and thus stress due to difference in stretchability between the cathode active material layer and the anode active material layer is not easily generated. As a result, occurrence of breakage of the anode current collector can be suppressed.

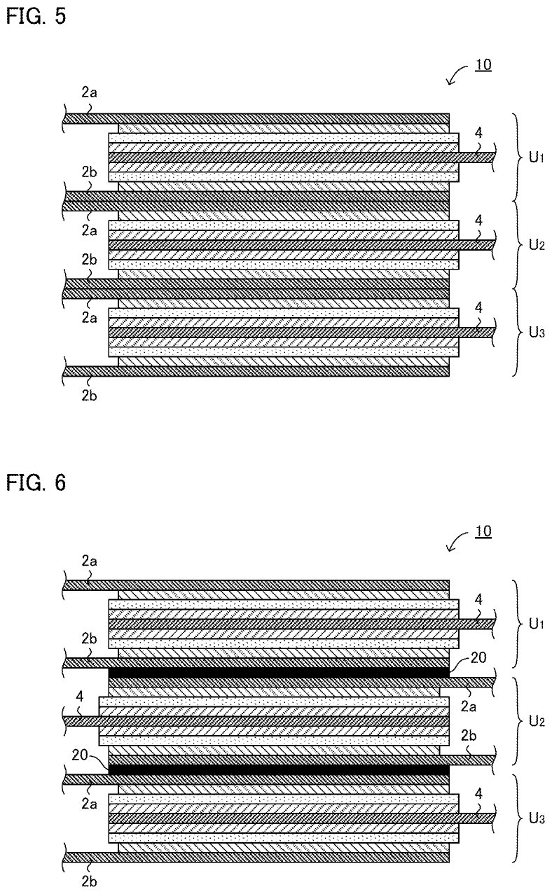

Also, the all solid state battery in the present disclosure may include a plurality of the unit cell U shown in FIG. 4. All solid state battery 10 shown in FIG. 5 includes a plurality of the unit cell U shown in FIG. 4 (unit cells U₁ to U₃), and the plurality of the unit cell U are connected in parallel. In specific, all the cathode current collector 2a and the cathode current collector 2b in the unit cells U₁ to U₃ are electronically connected, and all the anode current collector 4 in the unit cells U₁ to U₃ are electronically connected, and thus the unit cells U₁ to U₃ are connected in parallel. In some embodiments, at least one of the cathode current collector 2a and the cathode current collector 2b in the unit cells U₁ to U₃ is the above described high rigidity cathode current collector. Incidentally, in FIG. 5, the cathode current collector 2a and the cathode current collector 2b facing to each other (such as the cathode current collector 2b in the unit cell U₁ and the cathode current collector 2a in the unit cell U₂) are different members, but they may be the same member (one cathode current collector).

On the other hand, all solid state battery 10 shown in FIG. 6 includes a plurality of the unit cell U shown in FIG. 4 (unit cells U₁ to U₃), insulating member 20 is arranged in between each unit cell U, and the plurality of the unit cell U are connected in series. In specific, in unit cells U₁ to U₃, each of the cathode current collector 2a and the cathode current collector 2b are electronically connected, the anode current collector 4 in the unit cell U₁ is electronically connected with the cathode current collector 2a and the cathode current collector 2b in the unit cell U₂, and the anode current collector 4 in the unit cell U₂ is electronically connected with the cathode current collector 2a and the cathode current collector 2b in the unit cell U₃. In some embodiments, at least one of the cathode current collector 2a and the cathode current collector 2b in the unit cells U₁ to U₃ is the above described high rigidity cathode current collector.

Also, in the layered plurality of unit cells, the cathode current collector positioned in the outermost side is regarded as an outermost cathode current collector. For example, in FIG. 5 and FIG. 6, the cathode current collector 2a in the unit cell U₁ and the cathode current collector 2b in the unit cell U₃ respectively correspond to the outermost cathode current collector. In the present disclosure, the outermost cathode current collector is the high rigidity cathode current collector. Even when the conductive member pricks the all solid state battery to cause short circuit, the outermost cathode current collector being pulled inside the all solid state battery due to the conductive member can be inhibited. As a result, the calorific value can be further reduced. Also, as shown in FIG. 5 and FIG. 6, when the outermost cathode current collectors are present in the both ends, at least one of those outermost cathode current collectors is the high rigidity cathode current collector, and the both may be the high rigidity cathode current collector. Also, in the present disclosure, only the outermost cathode current collector may be the high rigidity cathode current collector. In this case, all the cathode current collectors other than the outermost cathode current collector may be low rigidity cathode current collectors, of which Young's modulus is smaller than 96.5 GPa.

The all solid state battery in the present disclosure may include an outer package for storing the cathode, the solid electrolyte layer, and the anode. The outer package may or may not be flexible. As an example of the former case, an aluminum laminate film can be exemplified, and as an example of the latter case, a case made of SUS can be exemplified.

Also, to the all solid state battery in the present disclosure, restraining pressure may be applied by a restraining jig. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

Also, the kind of the all solid state battery in the present disclosure is not particularly limited, but is typically an all solid lithium ion secondary battery. Further, examples of the application of the all solid state battery in the present disclosure may include a power source for vehicles such as hybrid electric vehicles, battery electric vehicles, fuel cell electric vehicles and diesel powered automobiles. In some embodiments, the all solid state battery is used as a power source for driving hybrid electric vehicles and battery electric vehicles. Also, the all solid state battery in the present disclosure may be used as a power source for moving bodies other than vehicles (such as railroad transportation, vessel and airplane), and may be used as a power source for electronic products such as information processing equipment.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Anode Active Material>

Si particles (from Kojundo Chemical Laboratory Co., Ltd.) 0.65 g and Li metal (from Honjo Metal Co., Ltd.) 0.60 g were mixed by an agate mortar under Ar atmosphere to obtain a LiSi precursor. Ethanol (from NACALAI TESQUE, INC.) at 0° C. 250 ml was added to the obtained LiSi precursor 1.0 g, and reaction thereof was conducted in a glass rector under Ar atmosphere for 120 minutes. After that, a solution and a solid reactant were separated by sucking filtration to collect the solid reactant. Acetic acid (from NACALAI TESQUE, INC.) 50 ml was added to the collected solid reactant 0.5 g, and the reaction thereof was conducted in a glass reactor under air atmosphere for 60 minutes. After that, a solution and a solid reactant were separated by sucking filtration to collect the solid reactant. The collected solid reactant was vacuum-dried at 100° C. for 2 hours to obtain an anode active material (nano-porous Si particles).

<Production of Anode>

The obtained anode active material (nano-porous Si particles, average particle size 0.5 μm), a sulfide solid electrolyte (10LiI 15LiBr·75(0.75Li₂S·0.25P₂S₅), average particle size 0.5 μm), a conductive material (VGCF-H), and a binder (SBR) were weighed so as to be the anode active material:the sulfide solid electrolyte:the conductive material:the binder=47.0:44.6:7.0:1.4 in the weight ratio, and mixed together with a dispersion medium (diisobutyl keton). The obtained mixture was dispersed by an ultrasonic homogenizer (UH-50 from SMT Corporation) to obtain slurry. The obtained slurry was pasted on one surface of an anode current collector (Ni foil, 22 μm thick) by a blade coating method using an applicator, and dried at 100° C. for 30 minutes. After that, pasting and drying were conducted in the same manner for the other surface of the anode current collector. Thereby, an anode including the anode current collector and the anode active material layer formed on the both surfaces of the anode current collector was obtained. The thickness of the anode active material layer (thickness of one surface) was 60 μm.

<Production of Member for Cathode>

A cathode active material coated with LiNbO₃ using a granulating-coating machine (LiNi_{0.8}Co_{0.15}Al_{0.05}O₂, average particle size 10 μm), a sulfide solid electrolyte (10LiI·15LiBr·75(0.75Li₂S·0.25P₂S₅), average particle size 0.5 μm), a conductive material (VGCF-H), and a binder (SBR) were weighed so as to be the cathode active material:the sulfide solid electrolyte:the conductive material:the binder=83.3:14.4:2.1:0.2 in the weight ratio, and mixed together with a dispersion medium (diisobutyl keton). The obtained mixture was dispersed by an ultrasonic homogenizer (UH-50 from SMT Corporation) to obtain slurry. The obtained slurry was pasted on Al foil (15 μm thick) by a blade coating method using an applicator, and dried at 100° C. for 30 minutes. Thereby, a member for cathode including the Al foil and the cathode active material layer was obtained. The thickness of the cathode active material layer was 100 μm.

<Production of Member for SE Layer>

A sulfide solid electrolyte (10LiI·15LiBr·75(0.75Li₂S·0.25P₂S₅), average particle size 2.0 μm) and a binder (SBR) were weighed so as to be the sulfide solid electrolyte:binder=99.6:0.4 in the weight ratio, and mixed together with a dispersion medium (diisobutyl keton). The obtained mixture was dispersed by an ultrasonic homogenizer (UH-50 from SMT Corporation) to obtain slurry. The obtained slurry was pasted on Al foil (15 μm thick) by a blade coating method using an applicator, and dried at 100° C. for 30 minutes. Thereby, a member for SE layer including the Al foil and the solid electrolyte layer was obtained. The thickness of the solid electrolyte layer was 50 μm.

<Production of All Solid State Battery>

The anode and the member for SE layer were cut out into the size of 7.2 cm by 7.2 cm respectively. Meanwhile, the member for cathode was cut out into the size of 7.0 cm by 7.0 cm.

The anode active material layer positioned on one surface side of the anode was made contact with the solid electrolyte layer of the member for SE layer, and the anode active material layer positioned on the other surface side of the anode was made contact with the solid electrolyte layer of the member for SE layer. The obtained layered body was pressed at the linear pressure of 1.6 t/cm by a roll-pressing method. Next, the Al foil of each of the solid electrolyte layer was respectively peeled off to expose the solid electrolyte layer.

After that, the cathode active material layer of the member for cathode was respectively made contact with the exposed solid electrolyte layer. The obtained layered body was pressed at the linear pressure of 1.6 t/cm by a roll-pressing method. Next, the Al foil of each of the cathode active material layer was respectively peeled off to expose the cathode active material layer, and further pressed at the linear pressure of 5 t/cm by a roll-pressing method. Next, a cathode current collector including a coating layer (Zn foil, 50 μm thick) was arranged respectively on the roll-pressed cathode active material layer. Incidentally, the coating layer was formed by weighing a conductive material (furnace black from Tokai Carbon Co., Ltd.) and PVDF (from KUREHA CORPORATION) to the conductive material:PVDF=85:15 in the volume ratio, mixing these with N-methyl pyrrolidone (NMP) to make slurry, pasting the slurry on a cathode current collector (Zn foil), and drying thereof. Next, a tab for collecting currents was respectively arranged on the cathode current collector and the anode current collector and sealed by laminate to obtain an all solid state battery.

### Example 2

An all solid state battery was obtained in the same manner as in Example 1, except that Fe foil (50 μm thick) was used as the cathode current collector.

### Example 3

An all solid state battery was obtained in the same manner as in Example 1, except that Ni foil (50 μm thick) was used as the cathode current collector.

### Comparative Example 1

An all solid state battery was obtained in the same manner as in Example 1, except that Al foil (50 μm thick) was used as the cathode current collector.

### Comparative Example 2

An all solid state battery was obtained in the same manner as in Example 1, except that Sn foil (50 μm thick) was used as the cathode current collector.

### Evaluation

Needle pricking tests were conducted to the all solid state batteries obtained in Examples 1 to 3 and Comparative Examples 1 and 2. In specific, the all solid state battery was restrained at 5 MPa using a restraining plate including a hole for needle pricking. After that, the battery was pricked by a needle having φ 3 mm at the point angle 30° in the condition of 0.1 mm/s speed and 1.2 mm depth, while being CC-CV charged (maximum current value 20 A) at 4.05 V. Calorific value (W) was calculated by the product of the voltage (V) and the inflow current (A). The results are shown in Table 1.

TABLE 1

| | Cathode current collector | | Calorific value |
|---|---|---|---|
| | Metal | Young's modulus (GPa) | (W) |
| Example 1 | Zn | 96.5 | 3.7 |
| Example 2 | Fe | 200 | 0.7 |
| Example 3 | Ni | 207 | 0.6 |
| Comparative | Al | 68.3 | 9.1 |
| Example 1 | | | |
| Comparative | Sn | 41.4 | 31.9 |
| Example 2 | | | |

As shown in Table 1, it was confirmed that the calorific values of Examples 1 to 3 were less than those of Comparative Examples 1 and 2. This is presumably because the Young's modulus of the cathode current collector used in Examples 1 to 3 was respectively higher than the Young's modulus of the cathode current collector used in Comparative Examples 1 and 2, and thus the cathode current collector being pulled inside the all solid state battery by the conductive member was inhibited.

REFERENCE SIGNS LIST

1 cathode active material layer

2 cathode current collector

3 anode active material layer

4 anode current collector

5 solid electrolyte layer

6 coating layer

10 all solid state battery

What is claimed is:

1. An all solid state battery comprising a cathode active material layer and a high rigidity cathode current collector, wherein
the high rigidity cathode current collector contains a metal element, and Young's modulus of the high rigidity cathode current collector is 96.5 GPa or more.

2. The all solid state battery according to claim 1, wherein the cathode active material layer and the high rigidity cathode current collector are in a non-contact state.

3. The all solid state battery according to claim 1, wherein the high rigidity cathode current collector contains, as the metal element, a first metal element of which Young's modulus in a simple substance of metal is 96.5 GPa or more.

4. The all solid state battery according to claim 3, wherein the high rigidity cathode current collector contains at least one kind of Zn, Fe, Ni, Pt, Ir, Re, W, Ta, Pd, Rh, Ru, Mo, Nb, Cu, Co, Mn, Cr, V, Ti and Be as the first metal element.

5. The all solid state battery according to claim 3, wherein the high rigidity cathode current collector contains Zn as the first metal element.

6. The all solid state battery according to claim 3, wherein the high rigidity cathode current collector contains Fe as the first metal element.

7. The all solid state battery according to claim 3, wherein the high rigidity cathode current collector contains Ni as the first metal element.

8. The all solid state battery according to claim 1, wherein the high rigidity cathode current collector is a simple substance of metal containing the metal element.

9. The all solid state battery according to claim 1, wherein the high rigidity cathode current collector is an alloy containing the metal element.

10. The all solid state battery according to claim 9, wherein the alloy contains a first metal element of which Young's modulus in a simple substance of metal is 96.5 GPa or more, and a second metal element of which Young's modulus in a simple substance of metal is less than 96.5 GPa.

11. The all solid state battery according to claim 1, wherein the high rigidity cathode current collector includes a coating layer containing a carbon material on a surface of the cathode active material layer side.

12. The all solid state battery according to claim 11, wherein the coating layer contains an inorganic filler.

13. The all solid state battery according to claim 1, wherein
the all solid state battery comprises a unit cell; and
the unit cell includes:
an anode current collector,
a first structure body arranged on one surface of the anode current collector, and
a second structure body arranged on the other surface of the anode current collector;
the first structure body includes a first anode active material layer, a first solid electrolyte layer, a first cathode active material layer and a first cathode current collector in an order along with a thickness direction from the anode current collector side;
the second structure body includes a second anode active material layer, a second solid electrolyte layer, a second cathode active material layer and a second cathode current collector in an order along with a thickness direction from the anode current collector side; and
at least one of the first cathode current collector and the second cathode current collector is the high rigidity cathode current collector.

14. The all solid state battery according to claim 1, wherein
the all solid state battery comprises a plurality of unit cells;
the plurality of unit cells are layered along with a thickness direction; and
in the layered plurality of unit cells, when a cathode current collector positioned in an outermost side is regarded as an outermost cathode current collector, only the outermost cathode current collector is the high rigidity cathode current collector.
